(19) United States
(12) Patent Application Publication
(10) Pub. No.: US 2025/0126527 A1
(43) Pub. Date: Apr. 17, 2025

(54) HANDOVER CONTROL OF COMMUNICATION DEVICE IN AT LEAST TWO LAYERS

(71) Applicant: RAKUTEN MOBILE, INC., Tokyo (JP)

(72) Inventors: Koichiro KITAGAWA, Tokyo (JP); Awn MUHAMMAD, Tokyo (JP)

(21) Appl. No.: 18/684,837

(22) PCT Filed: Jul. 21, 2023
(86) PCT No.: PCT/JP2023/026729

§ 371 Date: Feb. 20, 2024

(30) Foreign Application Priority Data
Feb. 16, 2023 (JP) 2023-022402

(51) Int. Cl. H04W 36/00; H04W 36/36

(52) U.S. Cl. CPC H04W 36/0058; H04W 36/362

(57) ABSTRACT

A communication control apparatus that controls handover of a communication device in two layers in a communication protocol hierarchy, includes at least one processor that performs: causing an upper-layer measurement reporter to report upper-layer communication quality of the one base station to the one base station in an upper layer; causing a state transitioner to transition the communication control apparatus to a lower-layer control state in which the handover control is enabled in a lower layer, if the upper-layer communication quality goes below a lower-layer control threshold; causing a lower-layer measurement reporter, in the lower-layer control state, to report lower-layer communication quality of the one base station to the one base station in the lower layer; and causing a handover determiner, in the lower-layer control state, to determine appropriateness of the handover in the lower layer based on the lower-layer communication quality.

### BACKGROUND OF THE INVENTION

### 1. Field of the Invention

The present disclosure relates to handover control of communication device in at least two layers.

### 2. Description of the Related Art

Number, types, and applications of wireless communication devices, hereinafter also collectively referred to as communication device, represented by smartphones or Internet of Things (IoT) devices, continue to increase. Wireless communication standards also continue to be expanded or improved. The commercial service of the fifth-generation mobile communication system known as “5G”, for example, started in 2018, and efforts still continue by 3GPP (Third Generation Partnership Project) for further developing its standards or specifications. Preliminary works have also started to develop new standards for “6G” or the sixth-generation mobile communication system, which would be the next-generation wireless communication standards following 5G.

In mobile communications, a communication device and/or a base station would move, which could lower the communication quality between them. Switching of base stations would occur, from one base station currently connected by the communication device, hereinafter collectively referred to as serving cell, to another base station, hereinafter collectively referred to as neighboring cell. Such a switching from the serving cell to the neighboring cell is triggered when the communication quality with the serving cell drops. It should be noted that the terms “serving cell” and “neighboring cell” refer not only to the corresponding base stations but also to communication cells provided by such base stations. Examples of such a switching of the communication device from the serving cell to the neighboring cell include the handover (in a narrower sense) and the redirection. In the handover, the communication device switches the base stations while maintaining its connection. In the redirection, the communication device disconnects from the serving cell and reconnects to the neighboring cell. After such a switching, the neighboring cell now connected by the communication device becomes the new serving cell. In the present specification, such various types of switching are collectively referred to as handover in a broader sense. Therefore, the handover technology according to the present disclosure is also applicable to the redirection or the like.

Handover of a communication device from a serving cell to a neighboring cell is generally performed in a specific layer in a communication protocol hierarchy. In 5G, for example, the third layer (L3: Layer 3) for handling radio resource control (RRC) or the like is responsible for the handover. In conventional handover control, the appropriateness of handover in L3 is determined based on the communication quality of the serving cell and/or the neighboring cell, which is measured by the communication device and reported to L3.
Patent Literature 1: US Patent Application Publication No. 2021/0168643

### SUMMARY OF THE INVENTION

In addition to the conventional handover control in L3, the handover control in a lower layer than L3 has been attempted. Examples of such a lower layer include the first layer (L1: Layer 1) as a physical layer, and the second layer (L2: Layer 2) for handling medium access control (MAC), radio link control (RLC), packet data convergence protocol (PDCP), service data adaptation protocol (SDAP) or the like. Such a technology is called “L1/L2 mobility”, while the conventional handover control in L3 is called “L3 handover”. In “L1/L2 mobility”, as in “L3 handover”, a communication device needs to measure the communication quality of the serving cell and/or the neighboring cell for reporting to the base station. However, in “L1/L2 mobility”, the load for measuring or reporting the communication quality at the communication device tends to become larger to realize a handover typically with greater speed and higher reliability than “L3 handover”. Therefore, performing “L1/L2 mobility” too frequently leads to increased power consumption of the communication device.

The present disclosure has been made in consideration of such circumstances for providing a communication control apparatus or the like that can efficiently measure or report communication quality by a communication device for handover determination.

A communication control apparatus in one embodiment of the present disclosure controls handover of a communication device from one base station to another base station in at least two layers in a communication protocol hierarchy. The communication control apparatus includes at least one processor that performs: causing an upper-layer measurement reporter to report upper-layer communication quality of at least the one base station measured by the communication device to at least the one base station in an upper layer of the two layers; causing a state transitioner to transition the communication control apparatus to a lower-layer control state in which the handover control is enabled in a lower layer of the two layers, if the upper-layer communication quality goes below a lower-layer control threshold; causing a lower-layer measurement reporter, in the lower-layer control state, to report lower-layer communication quality of at least the one base station measured by the communication device to at least the one base station in the lower layer; and causing a handover determiner, in the lower-layer control state, to determine appropriateness of the handover in the lower layer based on the lower-layer communication quality.

According to the embodiment, a transition is made to the lower-layer control state in which the handover control is enabled in a lower layer, e.g., L1 and/or L2 in 5G, if the measured value of the upper-layer communication quality reported in an upper layer, e.g., L3 in 5G, goes below the lower-layer control threshold. The measured value of the upper-layer communication quality is also referred to as L3 measurement in the context of 5G. In the lower-layer control state, the measured value of the lower-layer communication quality is reported from the communication device to the base station for handover determination in the lower layer. The measured value of the lower-layer communication quality is also referred to as L1/L2 measurement in the context of 5G. Thus, according to the embodiment, in the lower-layer control state, the communication quality, i.e., the lower-layer communication quality, can be efficiently reported by the communication device for the handover determination in the lower layer.

Another embodiment of the present disclosure is also a communication control apparatus that controls handover of a communication device from one base station to another base station in at least two layers in a communication protocol hierarchy. The communication control apparatus includes at least one processor that performs: causing a first measurement reporter to report first communication quality of the one base station measured by the communication device to the one base station in a lower layer of the two layers; causing a statistical value acquirer to acquire a statistical value of the first communication quality; causing a second measurement reporter to report second communication quality of the other base station measured by the communication device to the one base station in the lower layer, if the statistical value goes below a handover measurement threshold; and causing a handover determiner to determine appropriateness of the handover in the lower layer based on the first communication quality and the second communication quality.

According to the embodiment, the communication device measures the second communication quality of the neighboring cell, i.e., the other base station, for the handover determination in the lower layer, if the statistical value of the first communication quality of the serving cell, i.e., the one base station, measured by the communication device goes below the handover measurement threshold. Thus, according to the embodiment, the communication quality, i.e., the second communication quality, can be efficiently measured by the communication device for the handover determination in the lower layer.

Further another embodiment of the present disclosure is a communication control method that controls handover of a communication device from one base station to another base station in at least two layers in a communication protocol hierarchy. The communication control method performs by at least one processor: reporting upper-layer communication quality of at least the one base station measured by the communication device to at least the one base station in an upper layer of the two layers; transitioning to a lower-layer control state in which the handover control is enabled in a lower layer of the two layers, if the upper-layer communication quality goes below a lower-layer control threshold; in the lower-layer control state, reporting lower-layer communication quality of at least the one base station measured by the communication device to at least the one base station in the lower layer; and in the lower-layer control state, determining appropriateness of the handover in the lower layer based on the lower-layer communication quality.

Further another embodiment of the present disclosure is also a communication control method that controls handover of a communication device from one base station to another base station in at least two layers in a communication protocol hierarchy. The communication control method performs by at least one processor: reporting first communication quality of the one base station measured by the communication device to the one base station in a lower layer of the two layers; acquiring a statistical value of the first communication quality; reporting second communication quality of the other base station measured by the communication device to the one base station in the lower layer, if the statistical value goes below a handover measurement threshold; and determining appropriateness of the handover in the lower layer based on the first communication quality and the second communication quality.

Further another embodiment of the present disclosure is a computer-readable medium storing a communication control program that controls handover of a communication device from one base station to another base station in at least two layers in a communication protocol hierarchy. The communication control program causes at least one processer to perform: reporting upper-layer communication quality of at least the one base station measured by the communication device to at least the one base station in an upper layer of the two layers; transitioning to a lower-layer control state in which the handover control is enabled in a lower layer of the two layers, if the upper-layer communication quality goes below a lower-layer control threshold; in the lower-layer control state, reporting lower-layer communication quality of at least the one base station measured by the communication device to at least the one base station in the lower layer; and in the lower-layer control state, determining appropriateness of the handover in the lower layer based on the lower-layer communication quality.

Further another embodiment of the present disclosure is also a computer-readable medium storing a communication control program that controls handover of a communication device from one base station to another base station in at least two layers in a communication protocol hierarchy. The communication control program causes at least one processer to perform: reporting first communication quality of the one base station measured by the communication device to the one base station in a lower layer of the two layers; acquiring a statistical value of the first communication quality; reporting second communication quality of the other base station measured by the communication device to the one base station in the lower layer, if the statistical value goes below a handover measurement threshold; and determining appropriateness of the handover in the lower layer based on the first communication quality and the second communication quality.

It should be noted that any combination of the above components, or any conversion of the expression of the present disclosure among methods, devices, systems, storage media, computer programs and the like, are also encompassed within the present disclosure.

According to the present disclosure, measurement or reporting of communication quality by a communication device for handover determination can be efficiently made.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 schematically shows an overview of a wireless communication system to which the communication control apparatus is applied;

FIG. 2 is a functional block diagram of the communication control apparatus according to a first embodiment;

FIG. 3 schematically shows an example of the state transition of the communication control apparatus in accordance with upper-layer communication quality of a serving cell;

FIG. 4 schematically shows an example of the state transition of the communication control apparatus in accordance with lower-layer communication quality of a serving cell;

FIG. 5 schematically shows an example of the state transition of the communication control apparatus based on the examples in FIGS. 3 and 4;

FIG. 6 schematically shows the state transition of the communication control apparatus based on FIG. 5, focusing on the information communicated between a base station and a communication device;

FIG. 7 shows a modification of the state transition of the communication control apparatus;

FIG. 8 shows a modification of the state transition of the communication control apparatus;

FIG. 9 shows a modification of the state transition of the communication control apparatus;

FIG. 10 is a functional block diagram of the communication control apparatus according to a second embodiment; and

FIG. 11 is a flowchart showing an example of handover control in the lower layer.

### DETAILED DESCRIPTION OF THE INVENTION

The following is a detailed description of an exemplary implementation of the present disclosure, hereinafter also referred to as embodiment, with reference to the drawings. In the description and/or the drawings, identical or equivalent components, parts, processes, and the like will be given the same symbol to omit duplicate descriptions. The scale or shape of each portion shown in the drawings is set for convenience to simplify the description. Therefore, any of them should not be interpreted as limiting unless otherwise noted. Such illustrative embodiments will not limit the coverage of the present disclosure in any way. Not all features presented in the embodiments or combinations thereof are necessarily essential to the present disclosure.

The presented embodiments are broken down into respective components to realize each function and/or each function group for convenience. However, one component in an embodiment may actually be realized by a combination of a plurality of separate components. Conversely, a plurality of components in an embodiment may actually be realized by a single united component. In the descriptions of the wireless communication system according to the present embodiment, the terms in existing wireless communication standards such as 5G are used for convenience. This is not intended to limit the present disclosure to 5G or the like. Rather, the present disclosure can be applied to future wireless communication systems such as 6G, even if technologies similar to the present disclosure are provided under different names.

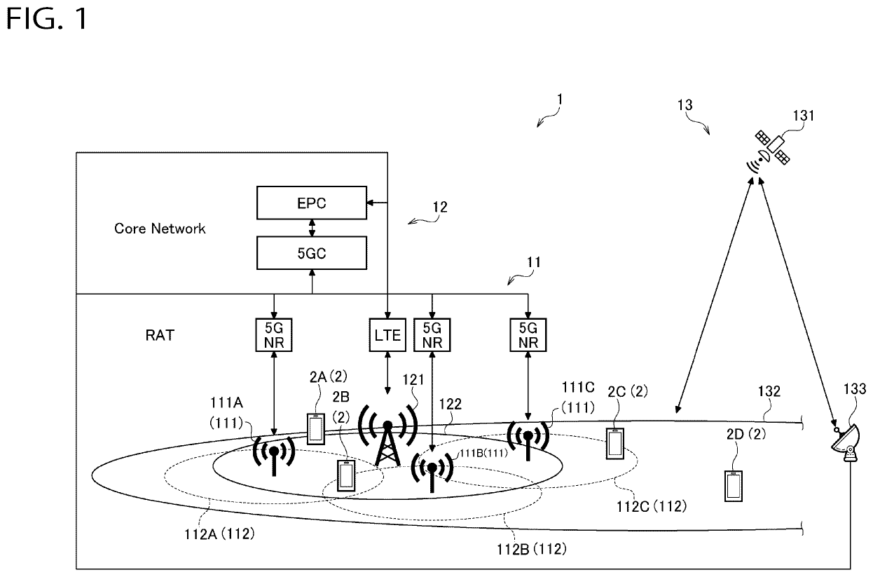

FIG. 1 schematically shows an overview of a wireless communication system 1 to which the communication control apparatus according to an embodiment of the present disclosure is applied. The wireless communication system 1 includes a 5G wireless communication system 11, a 4G wireless communication system 12, and a satellite communication system 13. The 5G wireless communication system 11 complies with the fifth-generation mobile communication (5G) system. The 5G system uses NR (New Radio) or 5G NR (Fifth Generation New Radio) as the radio access technology (RAT), and uses 5GC (Fifth Generation Core) as the core network (CN). The 4G wireless communication system 12 complies with the fourth-generation mobile communication (4G) system. The 4G system uses LTE (Long Term Evolution) or LTE-Advanced as the radio access technology, and uses EPC (Evolved Packet Core) as the core network. The satellite communication system 13 handles satellite communication via a communication satellite 131. Although not shown in the figure, the wireless communication system 1 may include: wireless communication systems of a generation prior to 4G; wireless communication systems of a generation later than 5G such as 6G; and any wireless communication systems not associated with those generations such as Wi-Fi (registered trademark). The wireless communication system 1 may not include some or all of the 5G wireless communication system 11, the 4G wireless communication system 12, and the satellite communication system 13.

The 5G wireless communication system 11 includes a plurality of 5G base stations 111A, 111B, and 111C installed on the ground, hereinafter also collectively referred to as 5G base station 111. The 5G base station 111 can communicate through 5G NR with communication devices 2A, 2B, 2C, and 2D, hereinafter also collectively referred to as communication device 2. The communication device 2 such as smartphone is also referred to as UE (User Equipment) or UT (User Terminal). The 5G base station 111 is also referred to as gNodeB (gNB). The coverage or support range of the respective 5G base stations 111A, 111B, and 111C is referred to as a cell. The respective cells 112A, 112B, and 112C, hereinafter also collectively referred to as 5G cell 112, is illustrated in the figure.

The size of the 5G cell 112 by the 5G base station 111 is arbitrary, but typically ranges from a few meters to several tens of kilometers in radius. Although there is no established definition, a cell with a radius of a few meters to ten meters may be called a femtocell, a cell with a radius of ten meters to several tens of meters may be called a picocell, a cell with a radius of several tens of meters to several hundreds of meters may be called a microcell, and a cell with a radius of more than several hundreds of meters may be called a macrocell. In 5G, high frequency radio waves such as millimeter waves are often used. Their high tendency to propagate in a straight-line causes the radio waves to be blocked by obstacles, shortening the communication distance. For this reason, 5G tends to use more small cells than 4G and earlier generations.

The communication device 2 can perform the 5G communication when it is located within at least one of the plurality of 5G cells 112A, 112B, and 112C. In the example shown in the figure, the communication device 2B in the 5G cells 112A and 112B can communicate with both the 5G base stations 111A and 111B through 5G NR. The communication device 2C in the 5G cell 112C can communicate with the 5G base station 111C through 5G NR. The communication devices 2A and 2D cannot communicate through 5G NR, as they are outside of all the 5G cells 112A, 112B, and 112C. The 5G communication based on 5G NR between each communication device 2 and each 5G base station 111 is managed by the 5GC as the core network. For example, the 5GC: transfers data to and from each 5G base station 111; transfers data to and from external networks such as the EPC, the satellite communication system 13, and the Internet; and handles mobility management of the communication device 2.

The 4G wireless communication system 12 includes a plurality of 4G base stations 121 installed on the ground (only one of them is illustrated in FIG. 1). The plurality of 4G base stations 121 can communicate through LTE or LTE-Advanced with the communication device 2. The 4G base station 121 is also referred to as eNodeB (eNB). The coverage or support range of the respective 4G base stations 121 is referred to as a cell, similar to the respective 5G base stations 111. Such a 4G cell 122 is illustrated in the figure.

The communication device 2 can perform the 4G communication when it is located within the 4G cell 122. In the example shown in the figure, the communication devices 2A and 2B in the 4G cell 122 can communicate with the 4G base station 121 through LTE or LTE-Advanced. The communication devices 2C and 2D cannot communicate through LTE or LTE-Advanced, as they are outside of the 4G cell 122. The 4G communication based on LTE or LTE-Advanced between each communication device 2 and each 4G base station 121 is managed by the EPC as the core network. For example, the EPC: transfers data to and from each 4G base station 121; transfers data to and from external networks such as the 5GC, the satellite communication system 13, and the Internet; and handles mobility management of the communication device 2.

If we take a look at each communication device 2A, 2B, 2C, and 2D in the example shown in the figure, the communication device 2A can perform the 4G communication with the 4G base station 121, the communication device 2B can perform the 5G communication with the 5G base stations 111A and 111B and the 4G communication with 4G base station 121, and the communication device 2C can perform the 5G communication with the 5G base station 111C. In case one communication device 2 (e.g., 2B) can communicate with a plurality of base stations (e.g., 111A, 111B, and 121), one base station is selected under the control of the 5GC and/or the EPC as the core network. For example, one base station is selected as the most suitable for the communication device 2B based on communication quality or the like. The communication device 2D cannot perform the communication with any of the 5G base stations 111 nor any of the 4G base stations 121. Therefore, the communication device 2D would perform the communication through the satellite communication system 13 described below.

The satellite communication system 13 is a wireless communication system using communication satellites 131 as non-terrestrial base stations. The communication satellite 131 may be a low-earth-orbit satellite flying in the low-earth-orbit outer space with altitude of 500 to 700 km above the ground. The coverage or support range of the communication satellite 131 is referred to as a cell, similar to the 5G base station 111 and the 4G base station 121. Such a satellite communication cell 132 is illustrated in the figure. As such, the communication satellite 131 as a non-terrestrial base station provides a satellite communication cell 132 as a non-terrestrial communication cell onto the ground. The communication device 2 on the ground can perform the satellite communication when it is located within the satellite communication cell 132. The communication satellite 131 as the base station in the satellite communication system 13 can perform wireless communication with the communication device 2 within the satellite communication cell 132, similar to the 5G base station 111 in the 5G wireless communication system 11 and the 4G base station 121 in the 4G wireless communication system 12. Such a wireless communication between the communication satellite 131 and the communication device 2 may be performed directly or indirectly via an aircraft or the like. The radio access technology used by the communication satellite 131 for wireless communication with the communication device 2 in the satellite communication cell 132 may be: 5G NR used by the 5G base station 111; LTE or LTE-Advanced used by the 4G base station 121; or any other radio access technology available for the communication device 2. Therefore, the communication device 2 does not have to be equipped with any special functions or components for the satellite communication.

The satellite communication system 13 is equipped with a gateway 133 as a ground station installed on the ground. The gateway 133 can communicate with the communication satellite 131. The gateway 133 is equipped with a satellite antenna for communicating with the communication satellite 131. The gateway 133 is also connected to the 5G base station 111 or the 4G base station 121 as the terrestrial base station that constitutes a terrestrial network (TN). Such a connection between the gateway 133 and the terrestrial base station can be established via: the above radio access technology such as 5G NR and LTE; or another wired or wireless access technology or interface. In such a manner, the gateway 133 connects the non-terrestrial network (NTN) constituted by the communication satellite 131 as the non-terrestrial base station or the satellite base station, and the terrestrial network TN constituted by the terrestrial base station 111 and 121. That is, the mutual communication between the non-terrestrial network NTN and the terrestrial network TN can be established via the gateway 133. In case the communication satellite 131 performs the 5G communication with the communication device 2 in the satellite communication cell 132 through 5G NR, the 5GC is used as the core network. In such a case, the communication satellite 131 is connected to the 5GC via the gateway 133, and the communication device 2 is connected to the 5GC via the 5G base station 111 or the 5G radio access network in the TN. In case the communication satellite 131 performs the 4G communication with the communication device 2 in the satellite communication cell 132 through LTE or LTE-Advanced, the EPC is used as the core network. In such a case, the communication satellite 131 is connected to the EPC via the gateway 133, and the communication device 2 is connected to the EPC via the 4G base station 121 or the 4G radio access network in the TN. In such a manner, appropriate coordination is made among different wireless communication systems such as the 5G wireless communication system 11, the 4G wireless communication system 12, and the satellite communication system 13 via the gateway 133.

The satellite communication through the communication satellites 131 is mainly used for covering areas with no or few terrestrial base stations such as the 5G base station 111 and the 4G base station 121. In the example shown in the figure, the communication device 2D located outside all the communication cells by the terrestrial base stations would communicate with the communication satellite 131. On the other hand, the communication devices 2A, 2B, and 2C also located inside the satellite communication cell 132 would not communicate with the communication satellite 131 in principle, even if they can. This is because they are in good communication with either of the terrestrial base stations. As such, the communication devices 2A, 2B, and 2C would communicate with the terrestrial base stations instead of the communication satellite 131, thereby saving the limited communication resources including power of the communication satellite 131 for use by the communication device 2D or the like. The communication satellite 131 uses beamforming to direct the communication radio waves to the communication device 2D in the satellite communication cell 132, thereby improving the communication quality with the communication device 2D.

The size of the satellite communication cell 132 by the communication satellite 131 as the satellite base station depends on the number of beams emitted by the communication satellite 131. For example, the satellite communication cell 132 with a diameter of approximately 24 km can be formed by combining up to 2,800 beams. As illustrated, the satellite communication cell 132 is typically larger than a terrestrial communication cell such as the 5G cell 112 and the 4G cell 122. Such a satellite communication cell 132 could contain one or more 5G cells 112 and/or 4G cells 122 inside it. The above example shows the communication satellite 131 as a flying non-terrestrial base station, which flies in the low-earth-orbit outer space with altitude of 500 to 700 km above the ground. However, a communication satellite flying in the geostationary orbit or other higher orbit in outer space, or an unmanned or manned aircraft or a drone flying in the stratosphere or other lower (e.g., approximately 20 km above the ground) atmosphere may be used as a non-terrestrial base station in addition to or instead of the communication satellite 131.

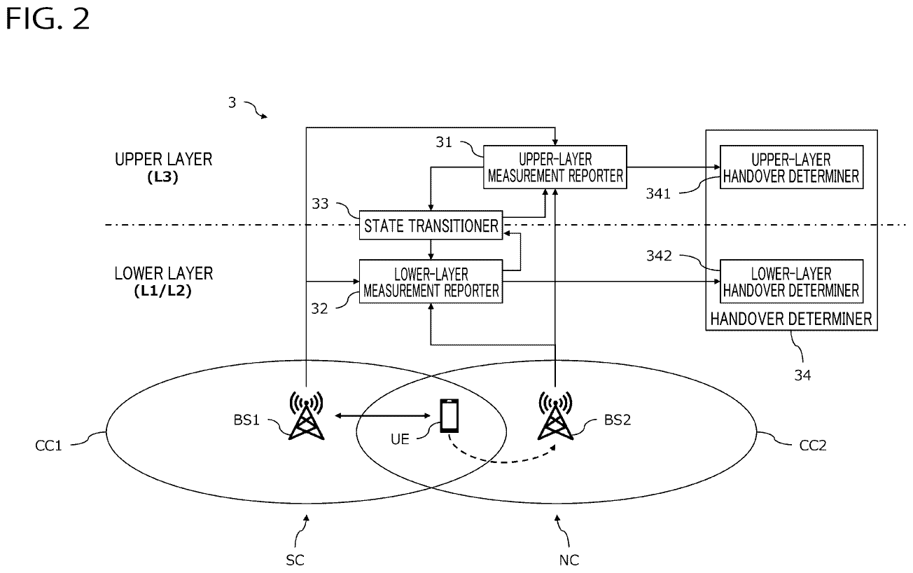

FIG. 2 is a functional block diagram of the communication control apparatus 3 according to the present embodiment. The communication control apparatus 3 includes an upper-layer measurement reporter 31, a lower-layer measurement reporter 32, a state transitioner 33, and a handover determiner 34. Some of the functional blocks can be omitted as long as the communication control apparatus 3 realizes at least some of the operations and/or the effects described below. The functional blocks are realized by the cooperation of hardware resources and software to be executed using them. Examples of such hardware resources include a central processing unit, a memory, an input device, and an output device of a computer, or a peripheral device connected to the computer. The types or the installation locations of the computer are freely selected. Each of the above functional blocks may be realized by hardware resources of a single computer, or by combining hardware resources distributed across a plurality of computers.

Especially in the present embodiment, some or all of the functional blocks of the communication control apparatus 3 may be realized in a centralized or distributed manner by computer or processor provided in at least one of: a communication device UE similar to the above communication device 2; base stations BS1 and BS2 similar to at least one of the above base stations 111, 121, and 131; unshown various communication stations (e.g., a relay station (a repeater), an IAB (Integrated Access and Backhaul) node, and the gateway 133) that constitute a radio access network (RAN) together with the base stations BS1 and BS2; and the core network.

The present embodiment describes the handover of the communication device UE in the example of 5G. In the illustrated example, the first base station BS1 providing the first communication cell CC1 constitutes the serving cell SC, and the second base station BS2 providing the second communication cell CC2 constitutes the neighboring cell NC. In other words, the communication device UE is connected to the first base station BS1 as the serving cell SC, and its handover to the second base station BS2 as the neighboring cell NC is controlled by the communication control apparatus 3.

There can be a plurality of serving cells SC and neighboring cells NC for one communication device UE. For example, different serving cells SC and neighboring cells NC may be assigned for communications related to the user plane (UP) and for communications related to the control plane (CP) of a single communication device UE. In case a single base station supports multiple transmission and reception points (TRPs) or multiple beams in relation to MIMO (Multi Input Multi Output) technology or the like, each TRP or each beam may function as a base station, i.e., the serving cell SC or the neighboring Cell NC.

The communication control apparatus 3 according to the present embodiment controls the handover of the communication device UE from the serving cell SC to the neighboring cell NC in at least two layers in a communication protocol hierarchy defined by 3GPP for NR. In the illustrated example, the handover of the communication device UE corresponding to the so-called “L3 handover” is performed at L3, which corresponds to the third layer in the communication protocol hierarchy defined by 3GPP for NR. The handover of the communication device UE corresponding to the so-called “L1/L2 mobility” is performed at L1 and/or L2. L1 corresponds to the first layer or the physical layer in the communication protocol hierarchy defined by 3GPP for NR, and L2 corresponds to the second layer in the same communication protocol hierarchy. In the present embodiment, L3 which is upper in the hierarchy is referred to as the upper layer or the higher layer, and L1 and/or L2 which is lower in the hierarchy is referred to as the lower layer for convenience. Although not explicitly mentioned in the present embodiment, there may be any other layers above L3, such as the transport layer, the session layer, the presentation layer, and the application layer.

As schematically shown in FIG. 2 for each functional block of the communication control apparatus 3 according to the present embodiment, the upper-layer measurement reporter 31 and the upper-layer handover determiner 341 in the handover determiner 34 are mainly responsible for processes related to the upper layer or L3, the lower-layer measurement reporter 32 and the lower-layer handover determiner 342 in the handover determiner 34 are mainly responsible for processes related to the lower layer or L1/L2, and the state transitioner 33 is responsible for processes across the upper layer or L3 and the lower layer or L1/L2.

The upper-layer measurement reporter 31, whose main portion is provided in the communication device UE, reports the communication quality of the serving cell SC and/or the neighboring cell NC measured by the communication device UE to the serving cell SC and/or the neighboring cell NC in the upper layer or L3. In the following, the communication quality of the serving cell SC and/or the neighboring cell NC measured by the upper-layer measurement reporter 31 or the communication device UE and reported in the upper layer or L3, is also referred to as the upper-layer communication quality or the L3 measurement. Here, the term “upper-layer communication quality” or “L3 measurement” means the communication quality to be reported in the upper layer or L3, not limiting the layer at which such communication quality has been measured or acquired. Therefore, the upper-layer communication quality or the L3 measurement is not limited to the communication quality acquired at the upper layer or L3 and reported in the upper layer or L3, but also includes the communication quality acquired at the lower layer or L1/L2 and reported in the upper layer or L3.

As described in detail below, the upper-layer handover determiner 341 in the handover determiner 34, in the upper-layer control state, determines the appropriateness of or whether to execute the handover in the upper layer or L3, i.e., the L3 handover, based on the upper-layer communication quality or the L3 measurement reported in the upper layer or L3 by the upper-layer measurement reporter 31.

The lower-layer measurement reporter 32, whose main portion is provided in the communication device UE, reports the communication quality of the serving cell SC and/or the neighboring cell NC measured by the communication device UE to the serving cell SC and/or the neighboring cell NC in the lower layer or L1/L2, in the lower-layer control state described below. In the following, the communication quality of the serving cell SC and/or the neighboring cell NC measured by the lower-layer measurement reporter 32 or the communication device UE and reported in the lower layer or L1/L2, is also referred to as the lower-layer communication quality or the L1/L2 measurement. Here, the term “lower-layer communication quality” or “L1/L2 measurement” means the communication quality acquired at the lower layer or L1/L2 and reported in the lower layer or L1/L2.

As described in detail below, the lower-layer handover determiner 342 in the handover determiner 34, in the lower-layer control state, determines the appropriateness of or whether to execute the handover in the lower layer or L1/L2, i.e., the L1/L2 mobility, based on the lower-layer communication quality or the L1/L2 measurement reported in the lower layer or L1/L2 by the lower-layer measurement reporter 32.

The following are examples of communication quality available for the handover control. Examples of the communication quality measured at L1 include: RSRP (Reference Signal Received Power) representing the received power of the reference signal transmitted from the base station; RSRQ (Reference Signal Received Quality) representing the received quality of the reference signal; and SINR (Signal-to-Interference-plus-Noise Ratio) representing the ratio of the signal and the interference or the noise. Examples of the communication quality measured at L2 include: packet transmission success rate related to MAC (Medium Access Control); number of retries related to HARQ (Hybrid Automatic Repeat Request); and number of retransmission requests related to RLC (Radio Link Control). Examples of the communication quality measured at L3 include: connection establishment time related to RRC (Radio Resource Control); packet delay time; and packet drop rate. In addition to the values of such parameters, their rates of change, especially rate of degradation of the communication quality, are also important in the handover control. The communication quality in the present embodiment also includes such rate of change of a parameter indicating the communication quality.

The communication quality acquired at each layer below L3 is the upper-layer communication quality or the L3 measurement described above, in case it is reported in the upper layer or L3 for the purpose of handover determination in the upper layer or L3 by the upper-layer handover determiner 341. On the other hand, such communication quality, except for those acquired at the upper layer or L3, is the lower-layer communication quality or the L1/L2 measurement described above, in case it is reported in the lower layer or L1/L2 for the purpose of handover determination in the lower layer or L1/L2 by the lower-layer handover determiner 342. As such, the upper-layer communication quality or the L3 measurement and the lower-layer communication quality or the L1/L2 measurement can contain common items despite the difference in the reported layers. However, in “L1/L2 mobility” realized based on the lower-layer communication quality or the L1/L2 measurement, the load for measuring or reporting, e.g., number of items, amount of information, and frequency, the communication quality, i.e., the lower-layer communication quality or the L1/L2 measurement, at the communication device UE or the lower-layer measurement reporter 32 tends to become larger. This is because “L1/L2 mobility” is aimed to realize a handover with greater speed and higher reliability than “L3 handover” realized based on the upper-layer communication quality or the L3 measurement.

For example, in “L3 handover”, the communication device UE or the upper-layer measurement reporter 31 is usually required to acquire the upper-layer communication quality or the L3 measurement every 10 ms, and transmit them as the L3 measurement report every 1 s to the base station, especially the first base station BS1 being connected, or the upper-layer handover determiner 341. In contrast, in “L1/L2 mobility”, the communication device UE or the lower-layer measurement reporter 32 may acquire the lower-layer communication quality or the L1/L2 measurement including more numbers of items or amount of information than the upper-layer communication quality or the L3 measurement at a frequency higher than every 10 ms, and transmit them as the L1/L2 measurement report to the base station, especially the first base station BS1 being connected, or the lower-layer handover determiner 342 at a frequency higher than every 1 s. As such, the reporting frequency of the upper-layer communication quality or the L3 measurement from the communication device UE by the upper-layer measurement reporter 31 may be lower than the reporting frequency of the lower-layer communication quality or the L1/L2 measurement from the communication device UE by the lower-layer measurement reporter 32.

As described above, “L1/L2 mobility” performed by the lower-layer measurement reporter 32 and the lower-layer handover determiner 342 can realize the faster and more reliable handover than “L3 handover” performed by the upper-layer measurement reporter 31 and the upper-layer handover determiner 341. On the other hand, in “L1/L2 mobility”, the load for measuring or reporting at the communication device UE or the lower-layer measurement reporter 32 tends to become larger, leading to increased power consumption of the communication device UE. Therefore, in the present embodiment, the state transitioner 33 described next is provided to prevent the excessive execution of “L1/L2 mobility”.

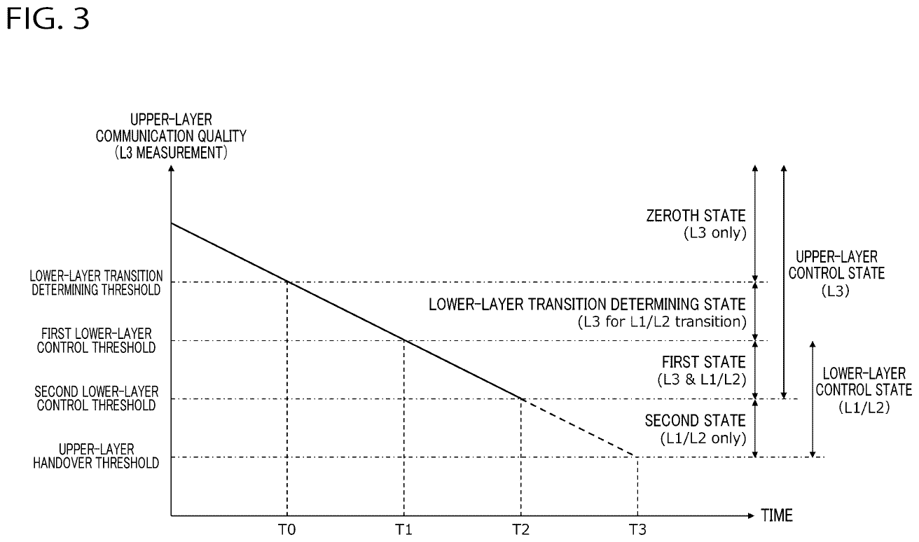

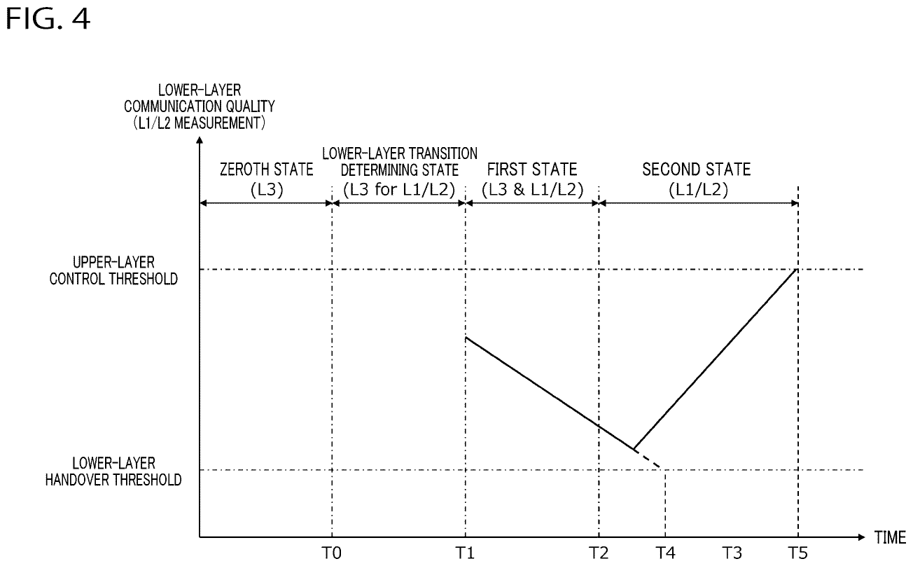

The state transitioner 33 transitions the communication control apparatus 3 to various states in accordance with the upper-layer communication quality or the L3 measurement reported in the upper layer or L3 by the upper-layer measurement reporter 31 and/or the lower-layer communication quality or the L1/L2 measurement reported in the lower layer or L1/L2 by the lower-layer measurement reporter 32. FIG. 3 schematically shows an example of the state transition of the communication control apparatus 3 in accordance with the upper-layer communication quality or the L3 measurement of the serving cell SC. FIG. 4 schematically shows an example of the state transition of the communication control apparatus 3 in accordance with the lower-layer communication quality or the L1/L2 measurement of the serving cell SC.

In FIGS. 3 and 4, each of the upper-layer communication quality or the L3 measurement and lower-layer communication quality or the L1/L2 measurement is shown as a scalar configured by a single parameter such as the RSRP above for convenience. However, each of the actual upper-layer communication quality or the L3 measurement and lower-layer communication quality or the L1/L2 measurement may be a vector configured by multiple parameters. In such a case, the various thresholds described below for the upper-layer communication quality or the L3 measurement and the lower-layer communication quality or the L1/L2 measurement are set as vectors.

FIGS. 3 and 4 show the upper-layer communication quality or the L3 measurement and the lower-layer communication quality or the L1/L2 measurement of the serving cell SC. Such a communication quality may be an absolute communication quality based solely on measurement of the serving cell SC, or a relative communication quality based on measurements of both serving cell SC and neighboring cell NC. Such a relative communication quality may be the communication quality of the serving cell SC subtracted by the communication quality of the neighboring cell NC, or the communication quality of the serving cell SC divided by the communication quality of the neighboring cell NC.

As shown in FIG. 3, the communication control apparatus 3 sequentially transitions to the zeroth state, the lower-layer transition determining state, the first state, and the second state, as the upper-layer communication quality or the L3 measurement of the serving cell SC goes down or the upper-layer communication quality or the L3 measurement of the neighboring cell NC relatively goes up. As explained in detail below, the zeroth state, the lower-layer transition determining state, and the first state are the upper-layer control states in which the handover control in the upper layer or L3, i.e., L3 handover, by the upper-layer handover determiner 341 is enabled. The first state and the second state are the lower-layer control states in which the handover control in the lower layer or L1/L2, i.e., L1/L2 mobility, by the lower-layer handover determiner 342 is enabled. In the first state which is both the upper-layer control state and the lower-layer control state, the handover control in the upper layer or L3, i.e., L3 handover, and the handover control in the lower layer or L1/L2, i.e., L1/L2 mobility, are both enabled.

In the zeroth state as the initial state in FIG. 3, the communication quality of the serving cell SC is monitored only in the upper layer or L3 in accordance with the conventional “L3 handover”, because the upper-layer communication quality or the L3 measurement of the serving cell SC is sufficiently high and the urgency of the handover to the neighboring cell NC is low.

The state transitioner 33 transitions the communication control apparatus 3 to the lower-layer transition determining state for determining the appropriateness of the transition to the lower-layer control state, upon the upper-layer communication quality or the L3 measurement of the serving cell SC going below the lower-layer transition determining threshold, higher than the first lower-layer control threshold described below, at time TO. In the lower-layer transition determining state, the communication quality of the serving cell SC is monitored only in the upper layer or L3, similar to the zeroth state. However, in the lower-layer transition determining state, measurement items, reporting items, determination criteria and the like different from the zeroth state may be set in the upper-layer measurement reporter 31, in order to examine the necessity of the transition to the lower-layer control state in particular. In such a case, the contents of the upper-layer communication quality or the L3 measurement reported by the communication device UE through the upper-layer measurement reporter 31 are different between the zeroth state above the lower-layer transition determining threshold and the lower-layer transition determining state below the lower-layer transition determining threshold in FIG. 3. In the lower-layer transition determining state, “L3 handover” may be disabled. In such a state, the L3 measurement may be made specifically for the purpose of determining the appropriateness of the transition to the lower-layer control state.

The upper-layer measurement reporter 31 preferably causes the communication device UE to report the upper-layer communication quality or the L3 measurement before and after going below the lower-layer transition determining threshold based on a common reporting format. Specifically, it is preferable that the L3 measurements which are common before going below the threshold in the zeroth state and after going below the threshold in the lower-layer transition determining state are reported using the common reporting format. It is also preferable that the upper-layer measurement reporter 31 causes the communication device UE to report the upper-layer communication quality or the L3 measurement, which is different between the zeroth state and the lower-layer transition determining state, as an additional information element to the common reporting format. As described above, the upper-layer communication quality could be different between the zeroth state and the lower-layer transition determining state, because of different measurement items, reporting items, determination criteria and the like.

The state transitioner 33 transitions the communication control apparatus 3 to the lower-layer control state in which the handover control in the lower layer or L1/L2, i.e., L1/L2 mobility, by the lower-layer handover determiner 342 is enabled, if the upper-layer communication quality or the L3 measurement of the serving cell SC goes below the first lower-layer control threshold at time T1 in the lower-layer transition determining state. In the examples in FIGS. 3 and 4, the lower-layer control state is divided into the first state and the second state. The communication control apparatus 3 transitions to the first state immediately after the upper-layer communication quality or the L3 measurement of the serving cell SC goes below the first lower-layer control threshold.

In the first state, the lower-layer communication quality or the L1/L2 measurement and the upper-layer communication quality or the L3 measurement are reported from the communication device UE. Therefore, in the first state, the handover control in the upper layer or L3, i.e., L3 handover, by the upper-layer handover determiner 341 is enabled, continuing from the zeroth state and the lower-layer transition determining state, in addition to the handover control in the lower layer or L1/L2, i.e., L1/L2 mobility, by the lower-layer handover determiner 342. As such, the upper-layer measurement reporter 31 may continue the reporting of the upper-layer communication quality or the L3 measurement from the communication device UE in the lower-layer control state or the first state.

In the first state, as shown in FIG. 3, the upper-layer handover determiner 341 determines that the handover should be executed in the upper layer or L3, i.e., L3 handover, when the upper-layer communication quality or the L3 measurement of the serving cell SC goes below the upper-layer handover threshold at time T3. As shown in FIG. 4, the lower-layer handover determiner 342 determines that the handover should be executed in the lower layer or L1/L2, i.e., L1/L2 mobility, when the lower-layer communication quality or the L1/L2 measurement of the serving cell SC goes below the lower-layer handover threshold at time T4.

It should be noted that, in the example in FIG. 3, the transition occurs to the second state in which the “L3 handover” is stopped, before the upper-layer communication quality or the L3 measurement of the serving cell SC goes below the upper-layer handover threshold. Therefore, the “L3 handover” at time T3 in FIG. 3 does not actually occur, which is why it is shown by the dotted line. However, in the modification described below without the second state, both “L3 handover” and “L1/L2 mobility” can occur in the first state or the lower-layer control state. The upper-layer handover threshold is a threshold for the upper-layer communication quality or the L3 measurement for the conventional “L3 handover”. However, each threshold for each state transition, e.g., the lower-layer transition determining threshold, the first lower-layer control threshold, and the second lower-layer control threshold in the example shown in FIG. 3, is set larger than the upper-layer handover threshold, so that the various state transitions in the present embodiment are made in enough time before time T3 when the conventional “L3 handover” occurs.

The state transitioner 33 transitions the communication control apparatus 3 from the first state to the second state, if at least one of the upper-layer communication quality or the L3 measurement and the lower-layer communication quality or the L1/L2 measurement of the serving cell SC goes below a further threshold in the first state. In the example in FIG. 3, the state transitioner 33 transitions the communication control apparatus 3 from the first state to the second state, if the upper-layer communication quality or the L3 measurement of the serving cell SC goes below the second lower-layer control threshold at time T2. In the second state, the lower-layer communication quality or the L1/L2 measurement is reported from the communication device UE, while the upper-layer communication quality or the L3 measurement is not reported from the communication device UE. Therefore, in the second state, the handover control only in the lower layer or L1/L2, i.e., L1/L2 mobility, by the lower-layer handover determiner 342 is enabled. As such, the upper-layer measurement reporter 31 may stop the reporting of the upper-layer communication quality or the L3 measurement from the communication device UE in the lower-layer control state or the second state.

In the second state, as shown by the dotted line in FIG. 4, the lower-layer handover determiner 342 determines that the handover should be executed in the lower layer or L1/L2, i.e., L1/L2 mobility, when the lower-layer communication quality or the L1/L2 measurement of the serving cell SC goes below the lower-layer handover threshold at time T4. On the other hand, as shown by the solid line in FIG. 4, the state transitioner 33 transitions the communication control apparatus 3 to the upper-layer control state, when the lower-layer communication quality or the L1/L2 measurement of the serving cell SC goes above the upper-layer control threshold at time T5 without going below the lower-layer handover threshold.

As described above, the upper-layer control state includes the zeroth state or the lower-layer transition determining state in which the handover control in the lower layer or L1/L2, i.e., L1/L2 mobility, is disabled, and the first state in which the handover control in the lower layer or L1/L2, i.e., L1/L2 mobility, is enabled. In such a case, the state transitioner 33 may directly transition the communication control apparatus 3 from the second state to the zeroth state or the lower-layer transition determining state, without going through the first state, if the lower-layer communication quality or the L1/L2 measurement of the serving cell SC goes above the upper-layer control threshold. Similarly, the state transitioner 33 may directly transition the communication control apparatus 3 from the lower-layer control state to the zeroth state, without going through the lower-layer transition determining state, if the lower-layer communication quality or the L1/L2 measurement of the serving cell SC goes above the upper-layer control threshold in the lower-layer control state, i.e., the first state or the second state.

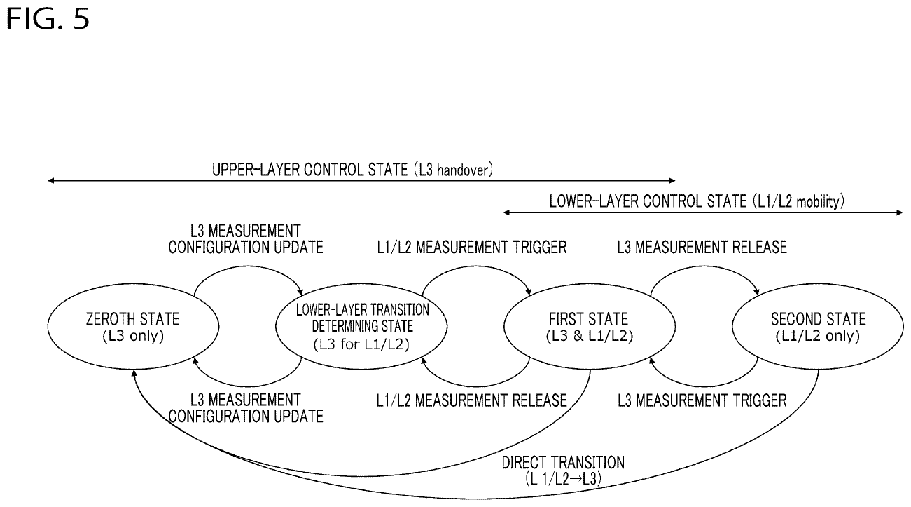

FIG. 5 schematically shows an example of the state transition of the communication control apparatus 3 based on the examples in FIGS. 3 and 4. As described above, the communication control apparatus 3 mainly takes four states: the zeroth state, the lower-layer transition determining state, the first state, and the second state.

The zeroth state and the lower-layer transition determining state are adjacent to each other. The communication control apparatus 3 can transition in the both directions based on the above lower-layer transition determining threshold for the upper-layer communication quality or the L3 measurement. In the transition from the zeroth state to the lower-layer transition determining state, the L3 measurement configuration, such as measurement items, reporting items, and determination criteria, in the upper-layer measurement reporter 31 is updated. Similarly, in the transition from the lower-layer transition determining state to the zeroth state, the L3 measurement configuration, such as measurement items, reporting items, and determination criteria, in the upper-layer measurement reporter 31 is updated or restored.

The lower-layer transition determining state and the first state are adjacent to each other. The communication control apparatus 3 can transition in the both directions based on the above first lower-layer control threshold for the upper-layer communication quality or the L3 measurement. In the transition from the lower-layer transition determining state to the first state, the reporting of the lower-layer communication quality or the L1/L2 measurement by the lower-layer measurement reporter 32 is initiated or triggered. In the transition from the first state to the lower-layer transition determining state, the reporting of the lower-layer communication quality or the L1/L2 measurement by the lower-layer measurement reporter 32 is stopped or released. As described above, the state transitioner 33 may directly transition the communication control apparatus 3 from the first state to the zeroth state, without going through the lower-layer transition determining state, if the lower-layer communication quality or the L1/L2 measurement and/or the upper-layer communication quality or the L3 measurement of the serving cell SC goes above the upper-layer control threshold (see FIG. 4) in the first state.

The first state and the second state are adjacent to each other. The communication control apparatus 3 can transition in the both directions based on the above threshold such as the second lower-layer control threshold in FIG. 3 for the upper-layer communication quality or the L3 measurement and/or the lower-layer communication quality or the L1/L2 measurement. In the transition from the first state to the second state, the reporting of the upper-layer communication quality or the L3 measurement by the upper-layer measurement reporter 31 is stopped or released. In the transition from the second state to the first state, the reporting of the upper-layer communication quality or the L3 measurement by the upper-layer measurement reporter 31 is initiated or triggered. As described above, the state transitioner 33 may directly transition the communication control apparatus 3 from the second state to the zeroth state, without going through the first state and the lower-layer transition determining state, if the lower-layer communication quality or the L1/L2 measurement of the serving cell SC goes above the upper-layer control threshold (see FIG. 4) in the second state.

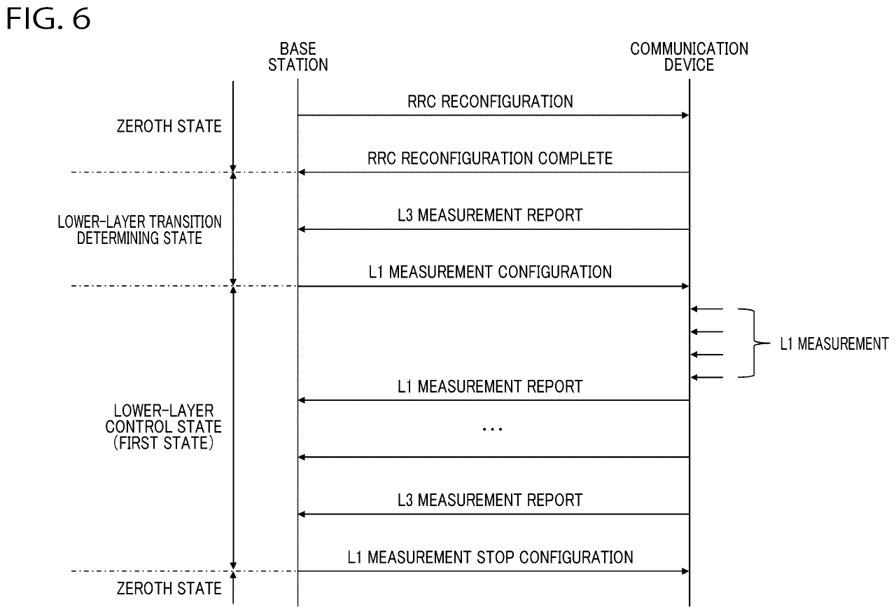

FIG. 6 schematically shows the state transition of the communication control apparatus 3 based on FIG. 5, focusing on the information communicated between a base station such as the first base station BS1 of the serving cell SC and a communication device UE. In the present figure, an example of communication concerning “L1 mobility”, which is a handover in L1, is shown as an embodiment of “L1/L2 mobility”. In the present figure, time progresses from top to bottom.

In the zeroth state, the base station BS1 transmits an RRC (Radio Resource Control) reconfiguration signal to the communication device UE for the transition to the lower-layer transition determining state, if the unshown upper-layer communication quality or the L3 measurement reported from the communication device UE to the base station BS1 goes below the lower-layer transition determining threshold (see FIG. 3). As described above, the RRC reconfiguration signal is to update or reconfigure the L3 measurement configuration, such as measurement items, reporting items, and determination criteria, in the upper-layer measurement reporter 31, for determining the appropriateness of the transition to the lower-layer control state. The communication device UE updates the configuration for the L3 measurement based on the received RRC reconfiguration signal and notifies the base station BS1 of its completion. With this, the communication control apparatus 3 transitions from the zeroth state to the lower-layer transition determining state.

In the lower-layer transition determining state, the communication device UE performs the L3 measurement, i.e., measurement of the upper-layer communication quality of the serving cell SC, the base station BS1, or the like, based on the configuration updated based on the RRC reconfiguration signal. Then, the communication device UE transmits the L3 measurement to the base station BS1 as the L3 measurement report. The base station BS1 transmits the information for the L1 measurement configuration to the communication device UE for the transition to the lower-layer control state or the first state, if the upper-layer communication quality in the L3 measurement report goes below the first lower-layer control threshold (see FIG. 3). With this, the communication control apparatus 3 transitions from the lower-layer transition determining state to the lower-layer control state or the first state.

The L1 measurement configuration information may be provided to the communication device UE from the base station BS1 through the RRC signal. Alternatively, the L1 measurement configuration information may be indicated to the communication device UE in advance in the broadcast information such as SIB (System Information Block) or the downlink information such as DCI (Downlink Control Information). However, it is highly likely that the details of the L1 measurement configuration information cannot be stored, because the SIB or the DCI has a limited amount of information storage. In such a case, the details of the L1 measurement configuration information can be stored in a table accessible by the communication device UE. Then, only an ID or a code uniquely specifying such a L1 measurement configuration information can be stored in the SIB or the DCI.

In the lower-layer control state or the first state, the communication device UE performs the L1 measurement, i.e., measurement of the lower-layer communication quality of the serving cell SC, the base station BS1, or the like, based on the configuration based on the L1 measurement configuration information. Then, the communication device UE transmits the L1 measurement to the base station BS1 as the L1 measurement report. As schematically illustrated in the figure, the frequency of the L1 measurement in the lower-layer control state or the first state is typically higher than the frequency of the L3 measurement (not shown) in the zeroth state or the like. In the lower-layer control state or the first state, the communication device UE may transmit the L3 measurement report to the base station BS1, continuing from the zeroth state and/or the lower-layer transition determining state.

In the example in FIG. 6, in the lower-layer control state or the first state, the handover in the lower layer or L1, i.e., L1 mobility, is not performed because the lower-layer communication quality or the L1 measurement in the L1 measurement report does not go below the lower-layer handover threshold (see FIG. 4), and the handover in the upper layer or L3, i.e., L3 handover, is not performed because the upper-layer communication quality or the L3 measurement in the L3 measurement report does not go below the upper-layer handover threshold (see FIG. 3). Furthermore, the base station BS1 transmits the configuration information for stopping the L1 measurement to the communication device UE, if the improved lower-layer communication quality or the L1 measurement in the L1 measurement report and/or the improved upper-layer communication quality or the L3 measurement in the L3 measurement report goes above the upper-layer control threshold (see FIG. 4). With this, the communication control apparatus 3 returns to the zeroth state in which only “L3 handover” is enabled.

According to the above embodiment, a transition is made to the lower-layer control state in which the handover control is enabled in the lower layer or L1/L2, if the measured value of the upper-layer communication quality or the L3 measurement reported in an upper layer or L3 goes below the lower-layer control threshold (see FIG. 3). In the lower-layer control state, the measured value of the lower-layer communication quality or the L1/L2 measurement is reported from the communication device UE to the serving cell SC or the like for handover determination in the lower layer. Thus, according to the present embodiment, in the lower-layer control state, the lower-layer communication quality can be efficiently reported by the communication device UE for the handover determination in the lower layer.

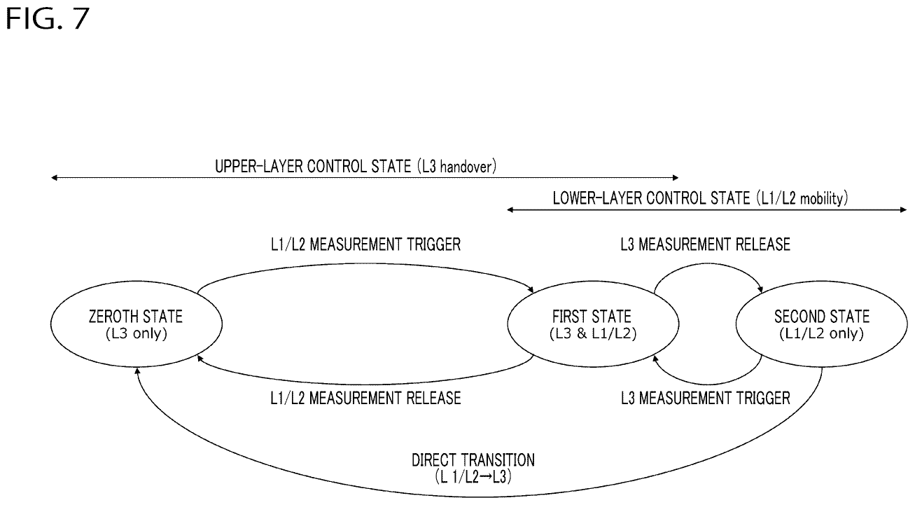

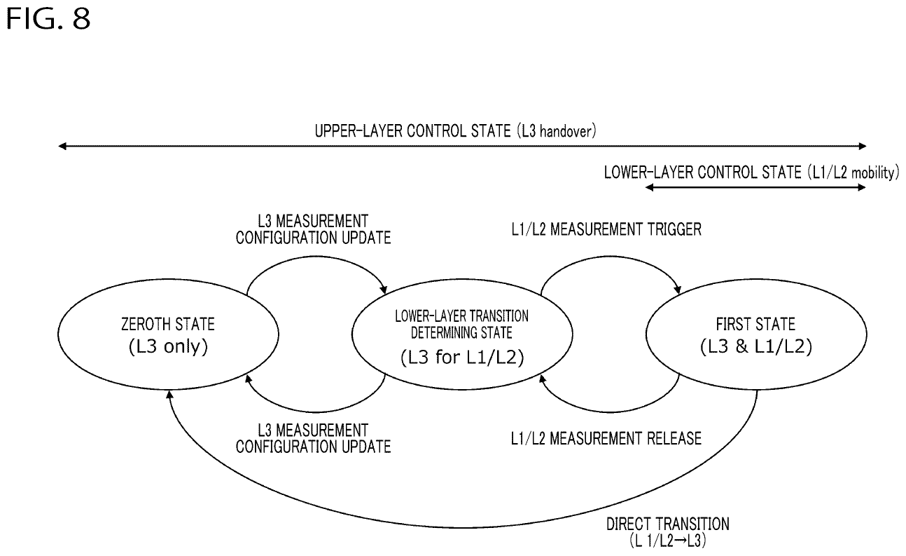

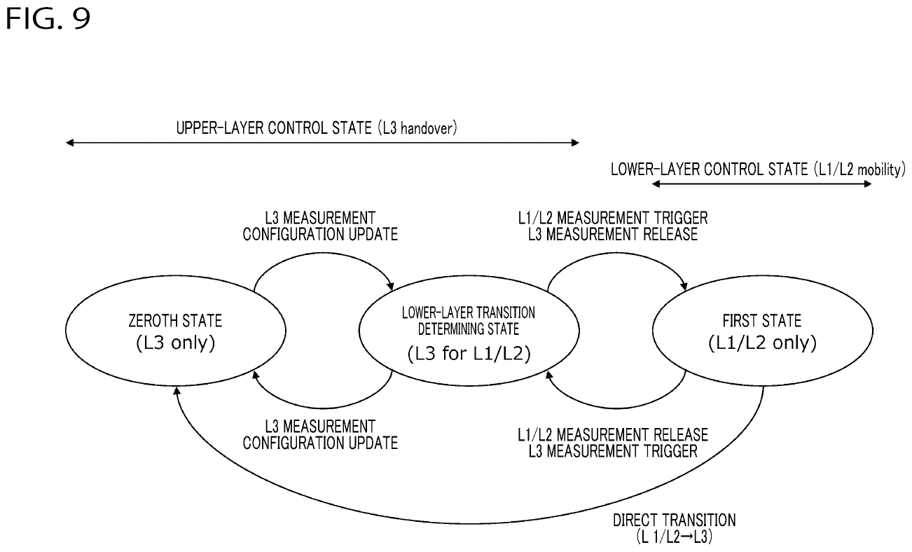

Various modifications are possible for the state transition of the communication control apparatus 3 as shown in FIG. 5. FIG. 7 shows a modification in which the lower-layer transition determining state is not set. FIG. 8 shows a modification in which only the first state is set as the lower-layer control state. FIG. 9 shows a modification in which only the second state is set as the lower-layer control state.

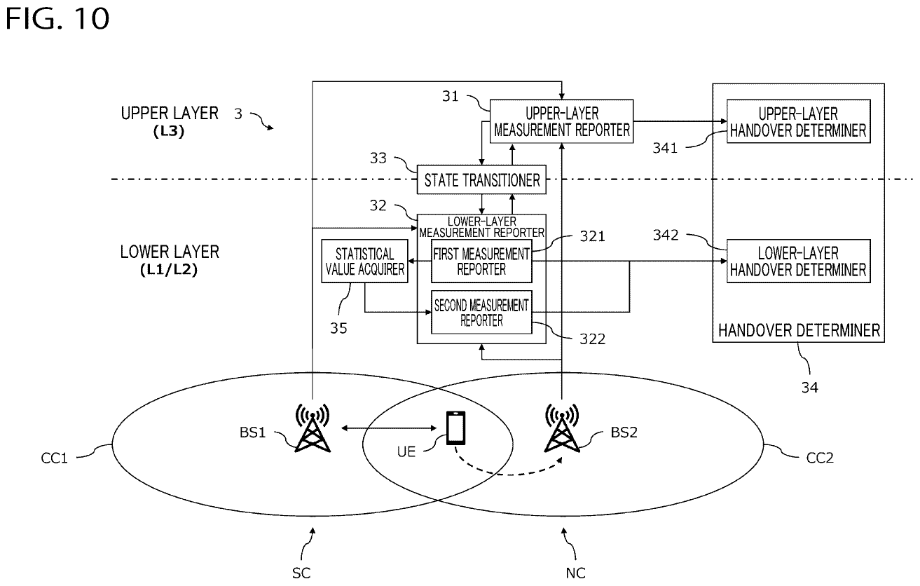

FIG. 10 shows a second embodiment of the communication control apparatus 3. In contrast to the first embodiment shown in FIG. 2, functional blocks related to the lower layer or L1/L2 have been added. Specifically, the statistical value acquirer 35 is additionally provided. In addition, the first measurement reporter 321 and the second measurement reporter 322 are additionally provided in the lower-layer measurement reporter 32. In the example of FIG. 10, the upper-layer measurement reporter 31, the state transitioner 33, and the upper-layer handover determiner 341 are provided as in FIG. 2, but at least some of them may be omitted.

The first measurement reporter 321, whose main portion is provided in the communication device UE, reports the first communication quality of the serving cell SC measured by the communication device UE to the serving cell SC in the lower layer or L1/L2, in the lower-layer control state as described above. Similarly, the second measurement reporter 322, whose main portion is provided in the communication device UE, reports the second communication quality of the neighboring cell NC measured by the communication device UE to the serving cell SC in the lower layer or L1/L2, in the lower-layer control state.

It is not necessary to have the communication device UE measure the second communication quality of the neighboring cell NC in addition to the first communication quality of the serving cell SC, if the urgency of the handover to the neighboring cell NC is low in the lower-layer control state. Therefore, the second communication quality of the neighboring cell NC is preferably measured by the communication device UE only when the first communication quality of the serving cell SC drops to some extent. However, for example, the first communication quality, which is the measured value of the communication radio waves of the serving cell SC in the first layer or L1 as the physical layer, significantly fluctuates. Therefore, the frequent occurrence of unnecessary measurements cannot be effectively prevented, if the communication device UE has to measure the second communication quality of the neighboring cell NC in accordance with the raw value of the first communication quality. As such, in the present embodiment, the statistical value acquirer 35 described next is provided to prevent the unnecessary measurements of the second communication quality.

The statistical value acquirer 35 acquires the statistical value of the first communication quality of the serving cell SC reported by the first measurement reporter 321. The statistical value is a numerical value acquired by applying any statistical process to the first communication quality that suppresses temporal fluctuations by considering the history or the like. A moving average is its example. The second measurement reporter 322 causes the second communication quality of the neighboring cell NC to be measured by the communication device UE, if the statistical value of the first communication quality of the serving cell SC acquired by the statistical value acquirer 35 goes below the handover measurement threshold (not shown). As such, the impact of the temporal fluctuations of the first communication quality of the serving cell SC can be reduced by using the statistical value. In addition, the second communication quality of the neighboring cell NC can be effectively measured and reported, if the urgency of the handover is high, e.g., if the statistical value goes below the handover measurement threshold.

The parameters concerning the measurement of the second communication quality of the neighboring cell NC by the second measurement reporter 322 can be set freely. Examples of such parameters include measurement cycle, number of neighboring cells NCs to be measured, frequency band to be measured. The lower-layer handover determiner 342 in the handover determiner 34 determines the appropriateness of or whether to execute the handover in the lower layer or L1/L2, i.e., the L1/L2 mobility, based on the first communication quality reported by the first measurement reporter 321 and the second communication quality reported by the second measurement reporter 322, in the lower-layer control state.

According to the present embodiment, the communication device UE measures the second communication quality of the neighboring cell NC for the handover determination in the lower layer, if the statistical value of the first communication quality of the serving cell SC measured by the communication device UE goes below the handover measurement threshold. Thus, according to the present embodiment, the communication quality, i.e., the second communication quality, can be efficiently measured by the communication device UE for the handover determination in the lower layer.

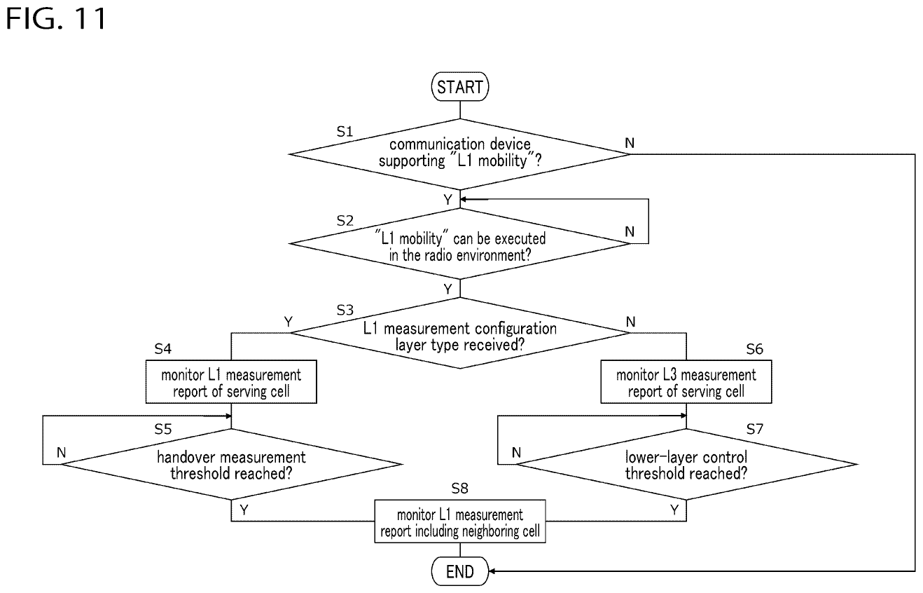

FIG. 11 is a flowchart showing an example of the handover control in the lower layer or L1/L2, i.e., L1/L2 mobility. “S” in the flowchart means a step or a process. In the present figure, a control example of “L1 mobility”, which is a handover at L1, is shown as an embodiment of “L1/L2 mobility.

In S1, it is determined whether the communication device UE supports “L1 mobility” for the handover control. If S1 is determined to be “No”, the processes concerning “L1 mobility” end and the handover control through the conventional “L3 handover” start. If S1 is determined to be “Yes”, the processes proceed to S2 to determine whether “L1 mobility” can be executed in the radio environment between the communication device UE and the serving cell SC and/or the neighboring cell NC. If S2 is determined to be “No”, the processes may wait until S2 is determined to be “Yes”, or the processes concerning “L1 mobility” may end and the handover control through the conventional “L3 handover” may start.

If S2 is determined to be “Yes”, the processes proceed to S3 to determine whether the serving cell SC or the first base station BS1 has received the measurement configuration layer type related to L1 from the communication device UE. The measurement configuration layer type is, for example, information specified by a pair of a layer in which the handover control should be performed and an event type related to the handover control.

In the example of the present figure, the layer in which the handover control should be performed is L1 (i.e., the lower layer) or L3 (i.e., the upper layer). The existing event types used in the conventional “L3 handover” may be used in L1, as the event types related to the handover control. Examples of the event type that may be used in L1 include: the “A2” event type that triggers the handover if the communication quality of the serving cell goes below a threshold; the “A3” event type that triggers the handover if the difference between the communication qualities of the neighboring cell and the serving cell goes above a threshold; and the “A5” event type that triggers the handover if the communication quality of the serving cell goes below a threshold and the communication quality of the neighboring cell goes above a threshold. The measurement configuration layer type transmitted by the communication device UE to the serving cell SC is expressed by a pair (e.g., “L1-A2”) of a layer in which the handover control should be performed (e.g., L1) and an event type related to the handover control (e.g., A2).

In S3, if the serving cell SC has received the measurement configuration layer type related to L1, such as “L1-A2”, “L1-A3”, or “L1-A5”, from the communication device UE, it is determined to be “Yes” to proceed to S4. In S3, if the serving cell SC has received the measurement configuration layer type related to L3, such as “L3-A2”, “L3-A3”, or “L3-A5”, from the communication device UE, it is determined to be “No” to proceed to S6.

S4 is performed by the first measurement reporter 321 and the statistical value acquirer 35 in FIG. 10. Specifically, the first measurement reporter 321 reports the first communication quality of the serving cell SC measured by the communication device UE to the serving cell SC as the L1 measurement report. Then, the statistical value acquirer 35 acquires the statistical value of the first communication quality of the serving cell SC reported by the first measurement reporter 321 as the monitoring target.

In S5, it is determined whether the statistical value of the first communication quality of the serving cell SC monitored in S4 has reached the above handover measurement threshold. If S5 is determined to be “No”, the processes wait until S5 is determined to be “Yes”. S5 is determined to be “Yes” if the statistical value of the first communication quality of the serving cell SC has gone below the handover measurement threshold, proceeding to S8.

In S8, the second measurement reporter 322 in FIG. 10 reports the second communication quality of the neighboring cell NC measured by the communication device UE to the serving cell SC as the L1 measurement report. Then, the lower-layer handover determiner 342 determines the appropriateness of or whether to execute the handover in L1, i.e., the L1 mobility, based on the first communication quality of the serving cell SC reported in S4 and the second communication quality of the neighboring cell NC reported in S8. by the second measurement reporter 322, in the lower-layer control state.

S6 is performed by the upper-layer measurement reporter 31 in FIG. 2. Specifically, the upper-layer measurement reporter 31 reports the upper-layer communication quality of the serving cell SC and/or the neighboring cell NC measured by the communication device UE to the serving cell SC and/or the neighboring cell NC as the L3 measurement report as the monitoring target.

In S7, it is determined whether the upper-layer communication quality of the serving cell SC and/or the neighboring cell NC monitored in S6 has reached the above lower-layer control threshold (see FIG. 3). If S7 is determined to be “No”, the processes wait until S7 is determined to be “Yes”. S7 is determined to be “Yes” if the upper-layer communication quality of the serving cell SC and/or the neighboring cell NC has gone below the lower-layer control threshold, proceeding to S8.

In S8, the lower-layer measurement reporter 32 in FIG. 2 reports the lower-layer communication quality of the serving cell SC and/or the neighboring cell NC measured by the communication device UE to the serving cell SC and/or the neighboring cell NC as the L1 measurement report. Then, the lower-layer handover determiner 342 determines the appropriateness of or whether to execute the handover in L1, i.e., the L1 mobility, based on the lower-layer communication quality of the serving cell SC and/or the neighboring cell NC reported in S8.

The present disclosure has been described above based on embodiments. It is obvious to those skilled in the art that various variations are possible in combinations of each component or each process disclosed in the exemplary embodiments, and that such variations are also encompassed within the scope of the present disclosure.

It should be noted that the structures, the operations, or the functions of each apparatus or each method described in the embodiments can be realized by hardware resources or software resources, or by cooperation of hardware resources and software resources. Processors, ROMs, RAMs, or various integrated circuits, for example, can be used as hardware resources. Programs such as operating systems and applications, for example, can be used as software resources.

The present disclosure may be expressed as the following items.

1. A communication control apparatus that controls handover of a communication device from one base station to another base station in at least two layers in a communication protocol hierarchy, comprising at least one processor that performs:
causing an upper-layer measurement reporter to report upper-layer communication quality of at least the one base station measured by the communication device to at least the one base station in an upper layer of the two layers;
causing a state transitioner to transition the communication control apparatus to a lower-layer control state in which the handover control is enabled in a lower layer of the two layers, if the upper-layer communication quality goes below a lower-layer control threshold;
causing a lower-layer measurement reporter, in the lower-layer control state, to report lower-layer communication quality of at least the one base station measured by the communication device to at least the one base station in the lower layer; and
causing a handover determiner, in the lower-layer control state, to determine appropriateness of the handover in the lower layer based on the lower-layer communication quality.
   2. The communication control apparatus according to item 1, wherein
the upper layer is the third layer or L3 in the communication protocol hierarchy defined by 3GPP for NR, and wherein the lower layer is at least one of the first layer or L1 and the second layer or L2 in the communication protocol hierarchy defined by 3GPP for NR.
   3. The communication control apparatus according to item 1 or 2, wherein the reporting frequency of the upper-layer
communication quality from the communication device by the upper-layer measurement reporter is lower than the reporting frequency of the lower-layer communication quality from the communication device by the lower-layer measurement reporter.
   4. The communication control apparatus according to any of items 1 to 3, wherein the handover determiner determines the appropriateness of the handover in the upper layer based on the upper-layer communication quality.
   5. The communication control apparatus according to any of items 1 to 4, wherein the upper-layer measurement reporter, in the lower-layer control state, stops the reporting of the upper-layer communication quality from the communication device.
   6. The communication control apparatus according to any of items 1 to 4, wherein the upper-layer measurement reporter, in the lower-layer control state, continues the reporting of the upper-layer communication quality from the communication device.
   7. The communication control apparatus according to any of items 1 to 6, wherein
the lower-layer control state includes a first state in which the lower-layer communication quality and the upper-layer communication quality are reported from the communication device, and a second state in which the lower-layer communication quality is reported from the communication device and the upper-layer communication quality is not reported from the communication device, and wherein
the state transitioner transitions the communication control apparatus to the first state, if the upper-layer communication quality goes below the lower-layer control threshold, and transitions the communication control apparatus from the first state to the second state, if at least one of the upper-layer communication quality and the lower-layer communication quality goes below a further threshold.
   8. The communication control apparatus according to item 7, wherein the state transitioner transitions the communication control apparatus from the second state to an upper-layer control state in which the handover control is disabled in the lower layer, without going through the first state, if the lower-layer communication quality goes above an upper-layer control threshold.
   9. The communication control apparatus according to any of items 1 to 8, wherein the state transitioner transitions the communication control apparatus to a lower-layer transition determining state for determining the appropriateness of the transition to the lower-layer control state, if the upper-layer communication quality goes below a lower-layer transition determining threshold which is higher than the lower-layer control threshold, and transitions the communication control apparatus from the lower-layer transition determining state to the lower-layer control state, if the upper-layer communication quality goes below the lower-layer control threshold.
   10. The communication control apparatus according to item 9, wherein the upper-layer measurement reporter causes the communication device to report the upper-layer communication quality before and after going below the lower-layer transition determining threshold based on a common reporting format.
   11. The communication control apparatus according to item 10, wherein the upper-layer measurement reporter sets different reporting items before and after the upper-layer communication quality goes below the lower-layer transition determining threshold, and causes the communication device to report the upper-layer communication quality corresponding to the different reporting items as an additional information element to the common reporting format.
   12. The communication control apparatus according to any of items 9 to 11, wherein the state transitioner transitions the communication control apparatus from the lower-layer control state to an upper-layer control state in which the handover control is disabled in the lower layer, without going through the lower-layer transition determining state, if the lower-layer communication quality goes above an upper-layer control threshold.
   13. A communication control apparatus that controls handover of a communication device from one base station to another base station in at least two layers in a communication protocol hierarchy, comprising at least one processor that performs:
causing a first measurement reporter to report first communication quality of the one base station measured by the communication device to the one base station in a lower layer of the two layers;
causing a statistical value acquirer to acquire a statistical value of the first communication quality;
causing a second measurement reporter to report second communication quality of the other base station measured by the communication device to the one base station in the lower layer, if the statistical value goes below a handover measurement threshold; and
causing a handover determiner to determine appropriateness of the handover in the lower layer based on the first communication quality and the second communication quality.
   14. A communication control method that controls handover of a communication device from one base station to another base station in at least two layers in a communication protocol hierarchy, performing by at least one processor:
reporting upper-layer communication quality of at least the one base station measured by the communication device to at least the one base station in an upper layer of the two layers;
transitioning to a lower-layer control state in which the handover control is enabled in a lower layer of the two layers, if the upper-layer communication quality goes below a lower-layer control threshold;
in the lower-layer control state, reporting lower-layer communication quality of at least the one base station measured by the communication device to at least the one base station in the lower layer; and
in the lower-layer control state, determining appropriateness of the handover in the lower layer based on the lower-layer communication quality.
   15. A communication control method that controls handover of a communication device from one base station to another base station in at least two layers in a communication protocol hierarchy, performing by at least one processor:
reporting first communication quality of the one base station measured by the communication device to the one base station in a lower layer of the two layers;
acquiring a statistical value of the first communication quality;
reporting second communication quality of the other base station measured by the communication device to the one base station in the lower layer, if the statistical value goes below a handover measurement threshold; and
determining appropriateness of the handover in the lower layer based on the first communication quality and the second communication quality.
   16. A computer-readable medium storing a communication control program that controls handover of a communication device from one base station to another base station in at least two layers in a communication protocol hierarchy, causing at least one processer to perform:
reporting upper-layer communication quality of at least the one base station measured by the communication device to at least the one base station in an upper layer of the two layers;
transitioning to a lower-layer control state in which the handover control is enabled in a lower layer of the two layers, if the upper-layer communication quality goes below a lower-layer control threshold;
in the lower-layer control state, reporting lower-layer communication quality of at least the one base station measured by the communication device to at least the one base station in the lower layer; and
in the lower-layer control state, determining appropriateness of the handover in the lower layer based on the lower-layer communication quality.
   17. A computer-readable medium storing a communication control program that controls handover of a communication device from one base station to another base station in at least two layers in a communication protocol hierarchy, causing at least one processer to perform:
reporting first communication quality of the one base station measured by the communication device to the one base station in a lower layer of the two layers;
acquiring a statistical value of the first communication quality;
reporting second communication quality of the other base station measured by the communication device to the one base station in the lower layer, if the statistical value goes below a handover measurement threshold; and
determining appropriateness of the handover in the lower layer based on the first communication quality and the second communication quality.

The present application claims priority of Japanese patent application 2023-22402, filed on Feb. 16, 2023, which hereby incorporated by reference in its entirety and is excerpted below.

The excerpt from Japanese patent application 2023-22402.

Title: Discussion on inter-cell beam management

### 1 Introduction

The work item on Further NR mobility enhancements was approved as in the WID [1]. Potential techniques for latency reduction in the mobility procedure have been discussed. In RAN1 #111 meeting, the following agreement was made as a list of further study topics.

### Agreement

For L1 measurement report for Rel-18 L1/L2 mobility, if UE event triggered report for L1 measurement is supported based on further study
At least the following aspects may be considered
   How to define UE event and exact definition of events,
   Report container
   Resource allocation/assignment for UE event triggered report
   Necessity of indication to gNB when the condition UE event is met, and how
   Necessity to define the condition to start/stop the reporting,
   Contents of the report/reporting format, PCI, RS ID, measurement result etc.
   The interaction with filtered L1 measurement results (if supported)
   Support of simultaneous configuration of both UE event triggered and any of periodic/semi-persistence/aperiodic reporting, and solutions when both of them are configured.
   Report destination, whether the report is sent to serving cell only or can be sent to one or more candidate cell(s).
   Benefit when L3 measurement is involved
      In this contribution, aspects related to the above aspects are discussed.

### 2 Discussion

Benefit of the event-based L1 measurement report L1 measurement report is discussed as a candidate signal to trigger L1 mobility procedure. According to the Rel-17 ICBM framework, inter-cell beam management is possible without L1 measurement report. By adopting event-based triggering of the measurement report, unnecessary signaling overhead can be reduced, depending on the trigger condition. If event-based L1 measurement report is supported, similar to L3 event-based measurement report, it is possible to start/stop periodic L1 measurement report based on the trigger/stop condition by configuring event types and necessary threshold parameters.

### Proposal 1

Agree to support event-based L1 measurement report.

### Some Details of L1 Measurement Report

To reduce unnecessary measurement report, serving cell received signal quality should be considered like event type A2. In addition, the report condition can consider beam quality of the neighboring cells, depending on the signalling overhead. Therefore, type A3 or A5 conditions are also potentially applicable.

### Proposal 2

The event for triggering the L1 measurement report, it should be able to evaluate at least serving cell beam quality.

As described in the previous paragraph, for the L1 measurement report management, the management framework of L3 measurement can be assumed as a starting point. Event condition can be utilized as the trigger of start/stop periodic measurement report. Key difference between L1 and L3 measurement report can be the periodicities. For example, since L1 measurement report should use each L1 measurement result for the evaluation of trigger condition of the measurement report, measurement report can be more dynamically triggered/stopped than L3 measurement report.

### Proposal 3

As a starting point of the measurement report management framework, L3 measurement report framework can be assumed.

Benefit when L3 measurement is involved Since L3 measurement report can be assumed to be available even when L1 measurement report is configured, to reduce the amount of measurement reports including L1 and L3, L3 measurement can be used to trigger monitoring of L1 measurement report. In order to reduce the signalling overhead, it may be necessary to discuss how to manage L1 and L3 measurement reports when both layers of measurement reports are configured to a UE.

### Proposal 4

It should be discussed how to manage L1 and L3 measurement reports, if supported.

### Proposal 5

L3 measurement report can be used to trigger monitoring of trigger condition of the L1 measurement report.

### 3 Conclusions

In this contributions, views on some aspects for L1 measurement reports are provided.

### Proposal 1

Agree to support event-based L1 measurement report.

### Proposal 2

The event for triggering the L1 measurement report, it should be able to evaluate at least serving cell beam quality.

### Proposal 3

As a starting point of the measurement report management framework, L3 measurement report framework can be assumed.

### Proposal 4

It should be discussed how to manage L1 and L3 measurement reports, if supported.

### Proposal 5

L3 measurement report can be used to trigger monitoring of trigger condition of the L1 measurement report.

### REFERENCES

[1] Ri-22xxxx WID

The present disclosure relates to handover control of communication device in at least two layers.
1 wireless communication system, 2 communication device, 3 communication control apparatus, 11 5G wireless communication system, 12 4G wireless communication system, 13 satellite communication system, 31 upper-layer measurement reporter, 32 lower-layer measurement reporter, 33 state transitioner, 34 handover determiner, 35 statistical value acquirer, 111 5G base station, 112 5G cell, 121 4G base station, 122 4G cell, 131 communication satellite, 132 satellite communication cell, 133 gateway, 321 first measurement reporter, 322 second measurement reporter, 341 upper-layer handover determiner, 342 lower-layer handover determiner, SC serving cell, NC neighboring cell.

1. A communication control apparatus that controls handover of a communication device from one base station to another base station in at least two layers in a communication protocol hierarchy, performing:
causing an upper-layer measurement reporter to report upper-layer communication quality of at least the one base station measured by the communication device to at least the one base station in an upper layer of the two layers;
causing a state transitioner to transition the communication control apparatus to a lower-layer control state in which the handover control is enabled in a lower layer of the two layers, if the upper-layer communication quality goes below a lower-layer control threshold;
causing a lower-layer measurement reporter, in the lower-layer control state, to report lower-layer communication quality of at least the one base station measured by the communication device to at least the one base station in the lower layer; and
causing a handover determiner, in the lower-layer control state, to determine appropriateness of the handover in the lower layer based on the lower-layer communication quality.

2. The communication control apparatus according to claim 1, wherein
the upper layer is the third layer or L3 in the communication protocol hierarchy defined by 3GPP for NR, and wherein
the lower layer is at least one of the first layer or L1 and the second layer or L2 in the communication protocol hierarchy defined by 3GPP for NR.

3. The communication control apparatus according to claim 1, wherein the reporting frequency of the upper-layer communication quality from the communication device by the upper-layer measurement reporter is lower than the reporting frequency of the lower-layer communication quality from the communication device by the lower-layer measurement reporter.

4. The communication control apparatus according to claim 1, wherein the handover determiner determines the appropriateness of the handover in the upper layer based on the upper-layer communication quality.

5. The communication control apparatus according to claim 1, wherein the upper-layer measurement reporter, in the lower-layer control state, stops the reporting of the upper-layer communication quality from the communication device.

6. The communication control apparatus according to claim 1, wherein the upper-layer measurement reporter, in the lower-layer control state, continues the reporting of the upper-layer communication quality from the communication device.

7. The communication control apparatus according to claim 1, wherein
the lower-layer control state includes a first state in which the lower-layer communication quality and the upper-layer communication quality are reported from the communication device, and a second state in which the lower-layer communication quality is reported from the communication device and the upper-layer communication quality is not reported from the communication device, and wherein
the state transitioner transitions the communication control apparatus to the first state, if the upper-layer communication quality goes below the lower-layer control threshold, and transitions the communication control apparatus from the first state to the second state, if at least one of the upper-layer communication quality and the lower-layer communication quality goes below a further threshold.

8. The communication control apparatus according to claim 7, wherein the state transitioner transitions the communication control apparatus from the second state to an upper-layer control state in which the handover control is disabled in the lower layer, without going through the first state, if the lower-layer communication quality goes above an upper-layer control threshold.

9. The communication control apparatus according to claim 1, wherein the state transitioner transitions the communication control apparatus to a lower-layer transition determining state for determining the appropriateness of the transition to the lower-layer control state, if the upper-layer communication quality goes below a lower-layer transition determining threshold which is higher than the lower-layer control threshold, and transitions the communication control apparatus from the lower-layer transition determining state to the lower-layer control state, if the upper-layer communication quality goes below the lower-layer control threshold.

10. The communication control apparatus according to claim 9, wherein the upper-layer measurement reporter causes the communication device to report the upper-layer communication quality before and after going below the lower-layer transition determining threshold based on a common reporting format.

11. The communication control apparatus according to claim 10, wherein the upper-layer measurement reporter sets different reporting items before and after the upper-layer communication quality goes below the lower-layer transition determining threshold, and causes the communication device to report the upper-layer communication quality corresponding to the different reporting items as an additional information element to the common reporting format.

12. The communication control apparatus according to claim 9, wherein the state transitioner transitions the communication control apparatus from the lower-layer control state to an upper-layer control state in which the handover control is disabled in the lower layer, without going through the lower-layer transition determining state, if the lower-layer communication quality goes above an upper-layer control threshold.

13. A communication control apparatus that controls handover of a communication device from one base station to another base station in at least two layers in a communication protocol hierarchy, performing:
causing a first measurement reporter to report first communication quality of the one base station measured by the communication device to the one base station in a lower layer of the two layers;
causing a statistical value acquirer to acquire a statistical value of the first communication quality;
causing a second measurement reporter to report second communication quality of the other base station measured by the communication device to the one base station in the lower layer, if the statistical value goes below a handover measurement threshold; and
causing a handover determiner to determine appropriateness of the handover in the lower layer based on the first communication quality and the second communication quality.

14. A communication control method that controls handover of a communication device from one base station to another base station in at least two layers in a communication protocol hierarchy, performing:
reporting upper-layer communication quality of at least the one base station measured by the communication device to at least the one base station in an upper layer of the two layers;
transitioning to a lower-layer control state in which the handover control is enabled in a lower layer of the two layers, if the upper-layer communication quality goes below a lower-layer control threshold;
in the lower-layer control state, reporting lower-layer communication quality of at least the one base station measured by the communication device to at least the one base station in the lower layer; and
in the lower-layer control state, determining appropriateness of the handover in the lower layer based on the lower-layer communication quality.

15-17. (canceled)
